(19) United States
(12) Patent Application Publication
(10) Pub. No.: US 2019/0276577 A1
(43) Pub. Date: Sep. 12, 2019

(54) SYNTHETIC POLYMER FILM AND PLASTIC PRODUCT WHICH INCLUDES SYNTHETIC POLYMER FILM

(71) Applicant: Sharp Kabushiki Kaisha, Sakai City (JP)

(72) Inventors: Yasuhiro SHIBAI, Sakai City (JP); Ken ATSUMO, Sakai City (JP); Tokio TAGUCHI, Sakai City (JP); Miho YAMADA, Sakai City (JP)

(21) Appl. No.: 16/293,903

(22) Filed: Mar. 6, 2019

(30) Foreign Application Priority Data
Mar. 7, 2018 (JP) 2018-041073

(51) Int. Cl. C08F 222/10; C08J 5/18

(52) U.S. Cl. CPC C08F 222/1006; C08J 2335/02; C08F 2222/1013; C08J 5/18

(57) ABSTRACT

A synthetic polymer film has a surface which has a plurality of raised portions, wherein when viewed in a normal direction of the synthetic polymer film, a two-dimensional size of the plurality of raised portions is in the range of more than 20 nm and less than 500 nm, the synthetic polymer film is made of a curable resin which contains a first polymerizable fluoric compound, the first polymerizable fluoric compound containing a fluorine element, the first polymerizable fluoric compound has a plurality of polymerizable functional groups and has a molecular weight of not less than 1000 and not more than 5000, and at the lapse of 5 minutes since placing a 200 μL drop of water on the surface of the synthetic polymer film, a pH of an aqueous solution is not less than 6.5 and not more than 7.5.

### BACKGROUND

### 1. Technical Field

The present invention relates to a synthetic polymer film and a plastic product including a synthetic polymer film.

### 2. Description of the Related Art

An antireflection technique which has been receiving attention in recent years is forming over a substrate surface a microscopic uneven pattern in which the interval of recessed portions or raised portions is not more than the wavelength of visible light (λ=380 nm to 780 nm). See Japanese Patent No. 4265729 and Japanese Laid-Open Patent Publication No. 2009-166502. The two-dimensional size of a raised portion of an uneven pattern which performs an antireflection function is not less than 10 nm and less than 500 nm. Here, the “two-dimensional size” of the raised portions refers to the area equivalent circle diameter of the raised portions viewed in a direction normal to the surface. For example, when the raised portions have a conical shape, the two-dimensional size of the raised portions is equivalent to the diameter of the base of the cone. The same applies to the “two-dimensional size” of the recessed portions.

The present applicant conceived a method for producing an antireflection film (an antireflection surface) which has a moth-eye structure with the use of an anodized porous alumina layer. Using the anodized porous alumina layer enables manufacture of a mold which has an inverted moth-eye structure with high mass-productivity (see, for example, Japanese Patent No. 4265729, Japanese Laid-Open Patent Publication No. 2009-166502, WO 2011/125486, and WO 2013/183576). The entire disclosures of Japanese Patent No. 4265729, Japanese Laid-Open Patent Publication No. 2009-166502, WO 2011/125486, and WO 2013/183576 are incorporated by reference in this specification.

The present applicant developed the above-described technology and arrived at a synthetic polymer film whose surface has a microbicidal effect (see, for example, WO 2015/163018). The entire disclosures of WO 2015/163018 are incorporated by reference in this specification.

A surface having a submicron-order uneven structure, which has ultrahydrophobicity, is known (see, for example, WO 2011/125970, WO 2016/174893, WO 2015/076309 and Japanese Laid-Open Patent Publication No. 2005-97371). It is known that the submicron-order uneven structure exhibits ultrahydrophobicity due to a so-called Lotus effect. Ultrahydrophobicity refers to that, for example, the static contact angle of water with respect to the surface is greater than 1500. A sheet or container which has an ultrahydrophobic surface can suppress or prevent proliferation of microorganisms even if the surface has no microbicidal ability, because the surface repels water. As disclosed in WO 2016/174893 of the present applicant and WO 2015/076309 and Japanese Laid-Open Patent Publication No. 2005-97371, surfaces which have anti-smear properties and oil repellency have been developed. A surface of excellent anti-smear properties refers to, for example, a surface from which smears (grease) can be easily wiped away. The entire disclosures of WO 2016/174893 are incorporated by reference in this specification.

### SUMMARY

According to research conducted by the present inventors, synthetic polymer films disclosed in WO 2011/125970, WO 2016/174893, WO 2015/076309 and Japanese Laid-Open Patent Publication No. 2005-97371 changed the pH of water (aqueous solution) on the surface in some cases. Therefore, the synthetic polymer films are not suitable in some cases, for example, when they are used for food purposes.

Major objects of the present invention include providing a synthetic polymer film whose surface has excellent water repellency and excellent anti-smear properties and which has a small influence on the pH of water (aqueous solution) on the surface and providing a plastic product which includes such a synthetic polymer film.

A synthetic polymer film of an embodiment of the present invention is a synthetic polymer film whose surface has a plurality of raised portions, wherein when viewed in a normal direction of the synthetic polymer film, a two-dimensional size of the plurality of raised portions is in the range of more than 20 nm and less than 500 nm, the synthetic polymer film is made of a curable resin which contains a first polymerizable fluoric compound, the first polymerizable fluoric compound containing a fluorine element, the first polymerizable fluoric compound has a plurality of polymerizable functional groups and has a molecular weight of not less than 1000 and not more than 5000, and at the lapse of 5 minutes since placing a 200 μL drop of water on the surface of the synthetic polymer film, a pH of an aqueous solution is not less than 6.5 and not more than 7.5. In one embodiment, the first polymerizable fluoric compound has a molecular weight of not less than 2000 and not more than 4000. In one embodiment, the proportion of the fluorine element contained in the first polymerizable fluoric compound is not less than 20 mass % and not more than 60 mass %.

In one embodiment, at the lapse of 5 minutes since placing a 200 μL drop of water on the surface of the synthetic polymer film, a pH of an aqueous solution is not less than 6.8 and not more than 7.2.

In one embodiment, the curable resin is a photocurable resin which contains a photopolymerization initiator, and the photopolymerization initiator contains at least one of the group consisting of ethanone,1-[9-ethyl-6-(2-methylbenzoyl)-9H-carbazole-3-yl]-,1-(O-acetyloxime), 2-hydroxy-1-{4-[4-(2-hydroxy-2-methyl-propionyl)-benzyl]-phenyl}-2-methyl-propan-1-one, and 1-[4-(2-hydroxyethoxy)-phenyl]-2-hydroxy-2-methyl-1-propane-1-one.

In one embodiment, the curable resin further contains a second polymerizable fluoric compound which contains a fluorine element, and the second polymerizable fluoric compound is a monofunctional polymerizable compound and has a molecular weight of not less than 100 and not more than 1000. In one embodiment, the second polymerizable fluoric compound has a molecular weight of not less than 300 and not more than 500. In one embodiment, the proportion of fluorine element contained in the second polymerizable fluoric compound is not less than 40 mass % and not more than 70 mass %.

In one embodiment, a proportion of the first polymerizable fluoric compound to the curable resin is not less than 1 mass % and not more than 5 mass %.

In one embodiment, a static contact angle of water with respect to the surface is not less than 1000. In one embodiment, a static contact angle of water with respect to the surface is not less than 1500°.

In one embodiment, a static contact angle of hexadecane with respect to the surface is not less than 50°. In one embodiment, a static contact angle of hexadecane with respect to the surface is not less than 90°.

In one embodiment, the synthetic polymer film includes a cross-linked structure, and the cross-linked structure includes a 2-(2-vinyloxy ethoxy)ethyl (meth)acrylate monomer unit.

A plastic product of an embodiment of the present invention includes: a plastic base which has a surface, and any of the above-described synthetic polymer films, the synthetic polymer film being provided on the surface of the plastic base.

In one embodiment, the surface of the plastic base is made of polycarbonate.

According to an embodiment of the present invention, a synthetic polymer film whose surface has excellent water repellency and excellent anti-smear properties and which has a small influence on the pH of water (aqueous solution) on the surface and a plastic product which includes such a synthetic polymer film are provided.

### BRIEF DESCRIPTION OF THE DRAWINGS

FIG. 1A and FIG. 1B are schematic cross-sectional views of synthetic polymer films 34A and 34B of an embodiment of the present invention respectively.

### DETAILED DESCRIPTION

Hereinafter, a synthetic polymer film and a synthetic polymer film production method according to an embodiment of the present invention are described with reference to the drawings.

The present applicant conceived a method for producing an antireflection film (an antireflection surface) which has a moth-eye structure with the use of an anodized porous alumina layer. Using the anodized porous alumina layer enables manufacture of a mold which has an inverted moth-eye structure with high mass-productivity.

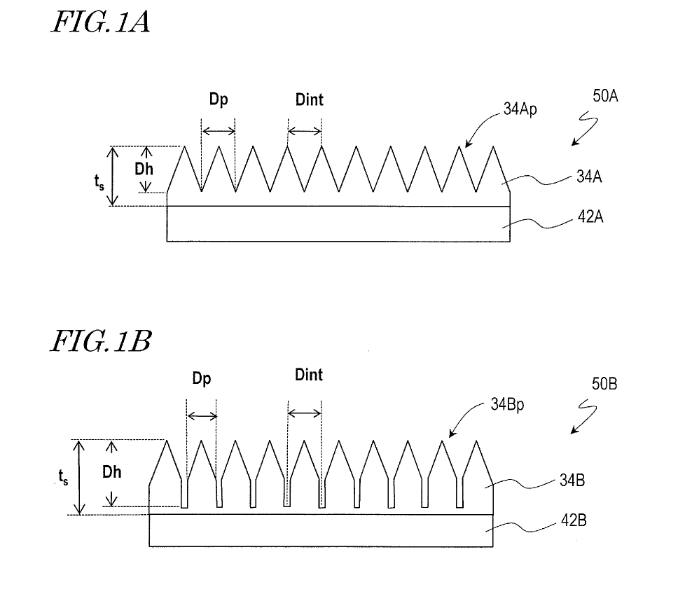

The configuration of a synthetic polymer film according to an embodiment of the present invention is described with reference to FIG. 1A and FIG. 1B.

FIG. 1A and FIG. 1B respectively show schematic cross-sectional views of synthetic polymer films 34A and 34B according to embodiments of the present invention. The synthetic polymer films 34A and 34B described herein as examples are formed on base films 42A and 42B, respectively, although the present invention is not limited to these examples. The synthetic polymer films 34A and 34B can be directly formed on a surface of an arbitrary object.

A film 50A shown in FIG. 1A includes a base film 42A and a synthetic polymer film 34A provided on the base film 42A. The synthetic polymer film 34A has a plurality of raised portions 34Ap over its surface. The plurality of raised portions 34Ap constitute a moth-eye structure. When viewed in a normal direction of the synthetic polymer film 34A, the two-dimensional size of the raised portions 34Ap, Dₚ, is in the range of more than 20 nm and less than 500 nm. Here, the “two-dimensional size” of the raised portions 34Ap refers to the diameter of a circle equivalent to the area of the raised portions 34Ap when viewed in a normal direction of the surface. When the raised portions 34Ap have a conical shape, for example, the two-dimensional size of the raised portions 34Ap is equivalent to the diameter of the base of the cone. The typical adjoining distance of the raised portions 34Ap, Dᵢₙₜ, is more than 20 nm and not more than 1000 nm. When the raised portions 34Ap are densely arranged so that there is no gap between adjoining raised portions 34Ap (e.g., the bases of the cones partially overlap each other) as shown in FIG. 1A, the two-dimensional size of the raised portions 34Ap, Dₚ, is equal to the adjoining distance Dᵢₙₜ. The typical height of the raised portions 34Ap, Dₕ, is not less than 50 nm and less than 500 nm. The height Dₕ of the raised portions 34Ap may be not more than 150 nm. The thickness of the synthetic polymer film 34A, tₛ, is not particularly limited but only needs to be greater than the height Dₕ of the raised portions 34Ap.

The synthetic polymer film 34A shown in FIG. 1A has the same moth-eye structure as the antireflection films disclosed in Japanese Patent No. 4265729, Japanese Laid-Open Patent Publication No. 2009-166502, WO 2011/125486 and WO 2013/183576. From the viewpoint of producing an antireflection function, it is preferred that the surface has no flat portion, and the raised portions 34Ap are densely arranged over the surface. Further, the raised portions 34Ap preferably has a such shape that the cross-sectional area (a cross section parallel to a plane which is orthogonal to an incoming light ray, e.g., a cross section parallel to the surface of the base film 42A) increases from the air side to the base film 42A side, e.g., a conical shape. From the viewpoint of suppressing interference of light, it is preferred that the raised portions 34Ap are arranged without regularity, preferably randomly. However, these features are unnecessary when the uneven structure of the synthetic polymer film 34A is utilized only for the purpose of achieving a so-called Lotus effect. For example, the raised portions 34Ap do not need to be densely arranged. The raised portions 34Ap may be regularly arranged.

A film 50B shown in FIG. 1B includes a base film 42B and a synthetic polymer film 34B provided on the base film 42B. The synthetic polymer film 34B has a plurality of raised portions 34Bp over its surface. The plurality of raised portions 34Bp constitute a moth-eye structure. In the film 50B, the configuration of the raised portions 34Bp of the synthetic polymer film 34B is different from that of the raised portions 34Ap of the synthetic polymer film 34A of the film 50A. Descriptions of features which are common with those of the film 50A are sometimes omitted.

When viewed in a normal direction of the synthetic polymer film 34B, the two-dimensional size of the raised portions 34Bp, Dₚ, is in the range of more than 20 nm and less than 500 nm. The typical adjoining distance of the raised portions 34Bp, Dᵢₙₜ, is more than 20 nm and not more than 1000 nm, and Dₚ<Dᵢₙₜ holds. That is, in the synthetic polymer film 34B, there is a flat portion between adjoining raised portions 34Bp. The raised portions 34Bp have the shape of a cylinder with a conical portion on the air side. The typical height of the raised portions 34Bp, Dₕ, is not less than 50 nm and less than 500 nm. The raised portions 34Bp may be arranged regularly or may be arranged irregularly. When the raised portions 34Bp are arranged regularly, Dᵢₙₜ also represents the period of the arrangement. This also applies to the synthetic polymer film 34A, as a matter of course.

In this specification, the “moth-eye structure” includes not only surficial nanostructures that have an excellent antireflection function and that are formed by raised portions which have such a shape that the cross-sectional area (a cross section parallel to the film surface) increases as do the raised portions 34Ap of the synthetic polymer film 34A shown in FIG. 1A but also surficial nanostructures that are formed by raised portions which have a part where the cross-sectional area (a cross section parallel to the film surface) is constant as do the raised portions 34Bp of the synthetic polymer film 34B shown in FIG. 1B. Note that, however, the tip of the conical portion may be rounded.

As disclosed in WO 2015/163018, the synthetic polymer film may further have a plurality of second raised portions which are superimposedly formed over a plurality of first raised portions. Herein, raised portions of the above-described synthetic polymer film which have a two-dimensional size in the range of more than 20 nm and less than 500 nm are referred to as “first raised portions”. The two-dimensional size of the second raised portions is smaller than the two-dimensional size of the first raised portions and does not exceed 100 nm.

A mold for forming the moth-eye structure such as illustrated in FIG. 1A and FIG. 1B over the surface (hereinafter, referred to as “moth-eye mold”) has an inverted moth-eye structure obtained by inverting the moth-eye structure. Using an anodized porous alumina layer which has the inverted moth-eye structure as a mold without any modification enables inexpensive production of the moth-eye structure. Particularly when a moth-eye mold in the shape of a hollow cylinder is used, the moth-eye structure can be efficiently manufactured according to a roll-to-roll method. Such a moth-eye mold can be manufactured according to methods disclosed in Japanese Laid-Open Patent Publication No. 2009-166502, WO 2011/125486, WO 2013/183576 and WO 2015/163018. That is, by alternately and repeatedly performing the anodization step and the etching step on an aluminum film deposited on a base or on an aluminum base through multiple cycles, a moth-eye mold is obtained which includes a porous alumina layer which has an inverted moth-eye structure.

The surface of the synthetic polymer film 34 has the moth-eye structure obtained by inverting the surficial nanostructure of the moth-eye mold. According to the surficial nanostructure of the moth-eye mold used, the synthetic polymer films 34A and 34B shown in FIG. 1A and FIG. 1B, respectively, can be produced. The material that forms the synthetic polymer film 34 is not limited to the UV-curable resin but may be a photocurable resin which is curable by visible light.

According to research conducted by the present inventors, it was found that when a synthetic polymer film 34 which has the above-described surface structure is produced using a curable resin which contains a polymerizable fluoric compound which has a plurality of polymerizable functional groups, a synthetic polymer film can be realized whose surface has excellent water repellency and excellent anti-smear properties and which has a small influence on the pH of water (aqueous solution) on the surface. Specifically, such a synthetic polymer film can be realized that, at the lapse of 5 minutes since placing a 200 μL drop of water on the surface of the synthetic polymer film, the pH of an aqueous solution is not less than 6.5 and not more than 7.5. The “anti-smear properties” include, for example, easiness in wiping away of grease adhered to the surface of the synthetic polymer film. It was also found that when the curable resin further contains a monofunctional polymerizable fluoric compound, a synthetic polymer film can be realized which is more excellent in water repellency and anti-smear properties.

[Synthetic Polymer Film]

Sample films which had the same configuration as the film 50A shown in FIG. 1A were produced using UV-curable resins of different compositions. The materials used in the curable resins for production of the synthetic polymer films of respective sample films are shown in TABLE 1A and TABLE 1B.

TABLE 1A

| | | | | | | | | | Number | |
|---|---|---|---|---|---|---|---|---|---|---|
| | | | | | | | | | of | |
| | | | | | | Water | | | moles | EO |
| MA- | | Product | Manufacturer | | | Sol- | EO | | of | mass |
| TERIALS | Abbreviation | Name | Name | Compound Name | Remarks | ubility | group | MW | EO | % |
| Monomer | M280 | M280 | MIWON | polyethylene glycol | | YES | YES | 508 | 9 | 78 |
| | | | | (400) diacrylate | | | | | | |
| | M282 | M282 | MIWON | polyethylene glycol | | YES | YES | 308 | 4 | 57 |
| | | | | (200) diacrylate | | | | | | |
| | VEEA | VEEA | NIPPON | 2-(2- | | YES | YES | 200 | 2 | 44 |
| | | | SHOKUBAI | vinyloxy ethoxy)ethyl | | | | | | |
| | | | CO., | acrylate | | | | | | |
| | | | LTD. | | | | | | | |
| | ACMO | ACMO | KJ Chemicals | N,N- | | YES | NO | 99 | — | — |
| | | | Corporation | acryloylmorpholine | | | | | | |
| Mold | MT70 | FOMBLIN ® | SOLVAY | perfluoropolyether | polymerizable, | NO | unknown | 3000 | — | — |
| Releasing | | MT70 | | derivative; 80% | tetrafunctional | | | | | |
| Agent | | | | methyl ethyl ketone | used after | | | | | |
| | | | | (solvent); 20% | substituted | | | | | |
| | | | | | with | | | | | |
| | | | | | ACMO | | | | | |
| | AD1700 | FLUOROLINK ® | SOLVAY | perfluoropolyether | polymerizable, | | | 3500 | — | — |
| | | AD1700 | | derivative; 70% | tetrafunctional | | | | | |
| | | | | ethyl acetate/butyl | used after | | | | | |
| | | | | acetate: 30% | substituted | | | | | |
| | | | | | with | | | | | |
| | | | | | ACMO | | | | | |
| | FAAC4 | CHEMINOX | UNIMATEC | 2- | polymerizable | NO | NO | 318 | — | — |
| | | FAAC-4 | Co., | (perfluorobutyl)ethyl | | | | | | |
| | | | Ltd. | acrylate | | | | | | |
| | FAAC6 | CHEMINOX | UNIMATEC | 2- | polymerizable | NO | NO | 418 | — | — |
| | | FAAC-6 | Co., | (perfluorohexyl)ethyl | | | | | | |
| | | | Ltd. | acrylate | | | | | | |
| | BYK3575 | BYK-3575 | BYK Japan | acrylic group | polymerizable | NO | unknown | — | — | — |
| | | | KK | containing, polyester | | | | | | |
| | | | | denatured | | | | | | |
| | | | | polydimethyl | | | | | | |
| | | | | siloxane; 50% | | | | | | |
| | | | | tripropylene glycol | polymerizable | NO | NO | — | — | — |
| | | | | diacrylate; 50% | | | | | | |
| | SAG003 | Silface | Nissin | silicone-based | not | NO | unknown | — | — | — |
| | | SAG003 | Chemical | surfactant | polymerizable | | | | | |
| | | | Industry | | | | | | | |
| | | | Co., | | | | | | | |
| | | | Ltd. | | | | | | | |

TABLE 1B

| | | | | | | | | | | |
|---|---|---|---|---|---|---|---|---|---|---|
| | | | | | | | | | Number | |
| | | | | | | | | | of | |
| | | | | | | | | | moles | |
| | | Product | Manufacturer | | | Water | EO | | of | EO |
| MATERIALS | Abbreviation | Name | Name | Compound Name | Remarks | Solubility | group | MW | EO | mass % |

| | | | | | | | | | |
|---|---|---|---|---|---|---|---|---|---|
| Polymerization | 819 | IRGACURE | IGM Resins | bis(2,4,6- | — | — | — | — | — |
| Initiator | | 819 | | trimethylbenzoyl)- | | | | | |
| | | | | phenylphosphine | | | | | |
| | | | | oxide | | | | | |
| | TPO | IRGACURE | IGM Resins | diphenyl(2,4,6- | — | — | — | — | — |
| | | TPO | | trimethylbenzoyl)phosphine | | | | | |
| | | | | oxide | | | | | |
| | OXE01 | IRGACURE | BASF | 1,2-Octanedione,1- | — | — | — | — | — |
| | | OXE01 | | [4-(phenylthio)phenyl]-, | | | | | |
| | | | | 2-(o- | | | | | |
| | | | | benzoyloxime) | | | | | |
| | 907 | Omnirad | IGM Resins | 2-methyl-1-(4- | — | — | — | — | — |
| | | 907 | | methylthiophenyl)- | | | | | |
| | | | | 2-morpholinopropan- | | | | | |
| | | | | 1-one | | | | | |
| | 369 | Omnirad | IGM Resins | 2-benzyl-2- | — | — | — | — | — |
| | | 369 | | dimethylamino-1-(4- | | | | | |
| | | | | morpholinophenyl)- | | | | | |
| | | | | butanone-1 | | | | | |
| | OXE02 | IRGACURE | BASF | ethanone,1-[9- | — | — | — | — | — |
| | | OXE02 | | ethyl-6-(2- | | | | | |
| | | | | methylbenzoyl)-9H- | | | | | |
| | | | | carbazol-3-yl]-,1- | | | | | |
| | | | | (O-acetyloxime) | | | | | |
| | 127 | Omnirad | IGM Resins | 2-hydroxy-1-{4-[4- | — | — | — | — | — |
| | | 127 | | (2-hydroxy-2- | | | | | |
| | | | | methyl-propionyl)- | | | | | |
| | | | | benzyl]-phenyl}-2- | | | | | |
| | | | | methyl-propan-1-one | | | | | |
| | 2959 | Omnirad | IGM Resins | 1-[4-(2- | — | — | — | — | — |
| | | 2959 | | hydroxyethoxy)- | | | | | |
| | | | | phenyl]-2-hydroxy- | | | | | |
| | | | | 2-methyl-1-propane- | | | | | |
| | | | | 1-one | | | | | |

Of the “Mold Releasing Agents” shown in TABLE 1A, MT70, AD1700, FAAC4 and FAAC6 contain a fluorine element and are polymerizable. Mold releasing agents MT70 and AD1700 have a plurality of polymerizable functional groups. That is, MT70 and AD1700 are polyfunctional polymerizable fluoric compounds. MT70 has a urethane methacrylate group. AD1700 has an acrylate group. The number of polymerizable functional groups included in each of MT70 and AD1700 is four. The molecular weights (MW) of MT70 and AD1700 in TABLE 1A represent weight average molecular weights measured by GPC (gel permeation chromatography) with a calibration with polystyrene standards.

Mold releasing agents FAAC4 and FAAC6 are monofunctional polymerizable fluoric compounds. That is, FAAC4 and FAAC6 each have one polymerizable functional group. The chemical structural formulae of FAAC4 and FAAC6 are shown at [CHEMICAL FORMULA 1] and [CHEMICAL FORMULA 2], respectively. The proportions of fluorine element contained in FAAC4 and FAAC6 are 53.7 mass % and 59.1 mass %, respectively.

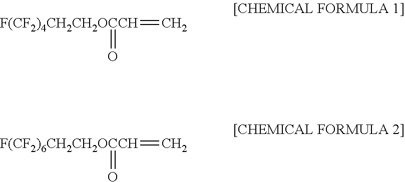

Mold releasing agents BYK3575 and SAG003 both contain silicone but do not contain a fluorine element. BYK3575 is polymerizable. SAG003 is not polymerizable.

The sample films produced were Reference Examples 1 to 8 which did not contain a polymerizable fluoric compound, Examples 1 to 6 according to an embodiment of the present invention, and Comparative Examples 1 to 5. Each of the sample films includes a base film (plastic base) 42A and a synthetic polymer film 34A provided on the base film 42A as does the film 50A shown in FIG. 1A. The compositions of the respective synthetic polymer films, the type of the base film, and the used mold samples are shown in TABLE 2 and TABLE 3. TABLE 2 shows the sample films of Reference Examples 1 to 8. TABLE 3 shows the sample films of Examples 1 to 6 and Comparative Examples 1 to 5.

Note that water was added to the UV-curable resin of Reference Examples 1 to 8 when it was used. Since it is estimated that the water hardly remains in the synthetic polymer films, water is not included in the compositions in TABLE 2. The amount of the added water was 5 g for 48.5 g of acrylic monomer M280. The ingredients of the total composition including water (100%) were: M280: 45.3%, M282: 45.3%, ACMO: 2.8%, polymerization initiator: 1.9% and water: 4.7%. The water used was distilled water manufactured by Wako Pure Chemical Corporation (manufacturer code: 041-16786).

As the base film 42A, a 50 μm thick PET (polyethylene terephthalate) film (“A4300” manufactured by TOYOBO CO., LTD.), an 80 μm thick TAC (triacetyl cellulose) film (“TAC-TD80U” manufactured by FUJIFILM) or a 110 μm thick PC (polycarbonate) film (“Iupilon KS3410UR” manufactured by Mitsubishi Engineering-Plastics Corporation (Iupilon is a registered trademark)) was used.

Each of the sample films was produced using a moth-eye mold through the following process.

For the moth-eye mold, an aluminum film (thickness: about 1 μm) was formed on a glass substrate (about 5 cm×about 5 cm), and anodization and etching were alternately and repeatedly performed on this aluminum film, whereby a porous alumina layer (Dₚ: about 200 nm, Dᵢₙₜ: about 200 nm, Dₕ: about 150 nm) was formed. Since the porous alumina layer has a structure obtained by inverting the moth-eye structure of the synthetic polymer film 34A, corresponding parameters which define the dimensions may sometimes be designated by the same symbols. Thereafter, a mold releasing treatment was performed on the surface of the moth-eye mold (the surface which has the inverted moth-eye structure). The mold releasing treatment was realized by applying a mold releasing agent (OPTOOL DSX manufactured by DAIKIN INDUSTRIES, LTD) by an immersion method.

The UV-curable resin applied to the surface of the base film 42A was irradiated with ultraviolet light (UV) with the moth-eye mold being pressed against the base film 42A, whereby the UV-curable resin was cured. Thereafter, the moth-eye mold was separated from the base film 42A, whereby a synthetic polymer film 34A to which the inverted moth-eye structure of the moth-eye mold was transferred was formed on the surface of the base film 42A. The exposure amount was about 200 mJ/cm² (on the basis of light at the wavelength of 375 nm). In each sample film, Dₚ was about 200 nm, Dᵢₙₜ was about 200 nm, and Dₕ was about 150 nm. In each sample, the synthetic polymer film was produced without using a solvent. In the ultraviolet light irradiation, a UV lamp manufactured by Fusion UV Systems (product name: LIGHT HANMAR6J6P3) was used.

When the PC film was used as the base film 42A (Examples 5 and 6), UV-curable resins of respective compositions were applied to the moth-eye mold while the moth-eye mold was heated to 20° C. or 40° C. on a heat stage. On the moth-eye mold to which the UV-curable resin was applied, the PC film was placed and evenly pressed against the mold using a hand roller. Then, the UV-curable resin was irradiated with ultraviolet light from the PC film side so as to be cured, whereby the sample film including the synthetic polymer film on the PC film was obtained. The process of producing the synthetic polymer film on the PC film is also referred to as “transfer process”. The temperature in that process (20° C. or 40° C.) is also referred to as “transfer temperature”.

TABLE 2

| | Monomer | | | Initiator | | | | | | | | Additive | Mold | Base |
|---|---|---|---|---|---|---|---|---|---|---|---|---|---|---|
| | M280 | M282 | ACMO | 819 | TPO | OXE01 | 907 | 369 | OXE02 | 127 | 2959 | Water | Sample | Film |
| Reference | 47.5% | 47.5% | 2.9% | 2.0% | | | | | | | | added | moth- | PET |
| Example 1 | | | | | | | | | | | | | eye | |
| | | | | | | | | | | | | | mold | |
| Reference | 47.5% | 47.5% | 2.9% | | 2.0% | | | | | | | added | moth- | PET |
| Example 2 | | | | | | | | | | | | | eye | |
| | | | | | | | | | | | | | mold | |
| Reference | 47.5% | 47.5% | 2.9% | | | 2.0% | | | | | | added | moth- | PET |
| Example 3 | | | | | | | | | | | | | eye | |
| | | | | | | | | | | | | | mold | |
| Reference | 47.5% | 47.5% | 2.9% | | | | 2.0% | | | | | added | moth- | PET |
| Example 4 | | | | | | | | | | | | | eye | |
| | | | | | | | | | | | | | mold | |
| Reference | 47.5% | 47.5% | 2.9% | | | | | 2.0% | | | | added | moth- | PET |
| Example 5 | | | | | | | | | | | | | eye | |
| | | | | | | | | | | | | | mold | |
| Reference | 47.5% | 47.5% | 2.9% | | | | | | 2.0% | | | added | moth- | PET |
| Example 6 | | | | | | | | | | | | | eye | |
| | | | | | | | | | | | | | mold | |
| Reference | 47.5% | 47.5% | 2.9% | | | | | | | 2.0% | | added | moth- | PET |
| Example 7 | | | | | | | | | | | | | eye | |
| | | | | | | | | | | | | | mold | |
| Reference | 47.5% | 47.5% | 2.9% | | | | | | | | 2.0% | added | moth- | PET |
| Example 8 | | | | | | | | | | | | | eye | |
| | | | | | | | | | | | | | mold | |

TABLE 3

| | | | | | | | | | Mold | |
|---|---|---|---|---|---|---|---|---|---|---|
| | | | | | | | | | Releasing Agent | |
| | | | | | | | | | fluorine- | |
| | | | | | | | | | containing, | |
| | | | | | | | | | poly- | |
| | | | | | | | | | functional | |
| | Monomer | | | | Initiator | | | | polymerizable | |
| | M280 | M282 | VEEA | ACMO | 819 | OXE02 | 127 | 2959 | MT70 | AD1700 |
| Comparative | 28.6% | 63.8% | | 2.9% | | 1.9% | | | | |
| Example 1 | | | | | | | | | | |
| Comparative | 28.3% | 61.3% | | 2.8% | | 1.9% | | | | |
| Example 2 | | | | | | | | | | |
| Comparative | 28.6% | 63.8% | | 2.9% | | 1.9% | | | | |
| Example 3 | | | | | | | | | | |
| Example 1 | 28.6% | 63.8% | | 2.9% | | 1.9% | | | 2.9% | |
| Example 2 | 28.0% | 62.6% | | 2.8% | | 1.9% | | | 1.9% | |
| Example 3 | 28.0% | 62.6% | | 2.8% | | 1.9% | | | 1.9% | |
| Example 4 | 28.0% | 62.6% | | 2.8% | | 1.9% | | | | 1.9% |
| Comparative | 28.0% | 62.6% | | 2.8% | | 1.9% | | | 1.9% | |
| Example 4 | | | | | | | | | | |
| Comparative | 28.0% | 62.6% | | 2.8% | 1.9% | | | | 1.9% | |
| Example 5 | | | | | | | | | | |
| Example 5 | 56.1% | | 37.4% | | | | 1.9% | | 1.9% | |
| Example 6 | 56.1% | | 37.4% | | | | | 1.9% | 1.9% | |

| | Mold Releasing Agent | | | | | |
|---|---|---|---|---|---|---|
| | fluorine- | | | | | |
| | containing, | | no fluorine | | | |
| | mono- | | contained | | | |
| | functional | | | not | | |
| | polymerizable | | | polymerizable | Mold | Base |
| | FAAC4 | FAAC6 | BYK3575 | SAG003 | Sample | Film |
| Comparative | | | | 2.9% | moth- | TAC |
| Example 1 | | | | | eye | |
| | | | | | mold | |
| Comparative | | | 5.7% | | moth- | TAC |
| Example 2 | | | | | eye | |
| | | | | | mold | |
| Comparative | 2.9% | | | | moth- | TAC |
| Example 3 | | | | | eye | |
| | | | | | mold | |
| Example 1 | | | | | moth- | TAC |
| | | | | | eye | |
| | | | | | mold | |
| Example 2 | 2.8% | | | | moth- | TAC |
| | | | | | eye | |
| | | | | | mold | |
| Example 3 | | 2.8% | | | moth- | TAC |
| | | | | | eye | |
| | | | | | mold | |
| Example 4 | | 2.8% | | | moth- | TAC |
| | | | | | eye | |
| | | | | | mold | |
| Comparative | | 2.8% | | | glass | TAC |
| Example 4 | | | | | plate | |
| Comparative | | 2.8% | | | moth- | TAC |
| Example 5 | | | | | eye | |
| | | | | | mold | |
| Example 5 | | 2.8% | | | moth- | PC |
| | | | | | eye | |
| | | | | | mold | |
| Example 6 | | 2.8% | | | moth- | PC |
| | | | | | eye | |
| | | | | | mold | |

The evaluation results of respective sample films as to the properties of the sample films, the adhesion between the synthetic polymer film and the base film, and the properties of the surfaces of the sample films (i.e., the surfaces of the synthetic polymer films) are shown in TABLE 4 and TABLE 5. TABLE 4 shows the evaluation results of the sample films of Reference Examples 1 to 8. TABLE 5 shows the evaluation results of the sample films of Examples 1 to 6 and Comparative Examples 1 to 5. For the properties of the sample films, evaluation of coloring and smell of the sample films and identification of acid were carried out. The evaluated surface properties of the sample films were the spreadability of a water drop over the surface of the synthetic polymer film, the change of the pH of the water drop, the static contact angle of water or hexadecane with respect to the surface, and the anti-smear properties.

[Evaluation of Sample Film Properties]

Coloring

Coloring of the sample films (the degree of yellowing) was visually observed.

∘: Transparent with no color even when 10 sheets of the sample film were stacked up;

Δ: Single sheet was transparent with no color, but yellowed portions were detected when 10 sheets of the sample film were stacked up;

x: Yellowed portions were detected in a single sheet of the sample film.

Herein, when ∘ or Δ, the sample film was judged to be usable.

Smell

The presence/absence (degree) of a smell of the sample films was evaluated as follows. A 5 cm×5 cm piece of the sample films was placed in a 100 mL glass container. The container was tightly closed and left in an incubator at 40° C. for 24 hours. After being left for 24 hours, five panelists smelled and evaluated the degree of the smell in the container immediately after the container was opened.

∘: Panelists noticed a faint smell, but the smell was not unpleasant;

Δ: Panelists noticed a smell, but the smell was not unpleasant;

x: Panelists noticed an unpleasant smell.

Herein, when ∘ or Δ, the sample film was judged to be usable.

[Identification of Acid]

An acid extracted from each sample film to water was identified as described below using GC-MS (gas chromatograph mass spectrometer).

10 mL THF per 100 cm² of each sample film was put into a glass container. The sample film was immersed in THF at 50° C. for 3 days. Then, THF was passed through a 0.45 μm membrane filter.

0.1 mL of the filtered solution was condensed in a pyrolysis sample cup. The condensed solution was methylated by adding a 10 μL methylating agent (Tetramethylammonium Hydroxide) aqueous solution. Thereafter, the measurement was carried out under the following conditions.

Pyrolyzer: EGA/PY-3030D manufactured by FRONTIER LAB

Conditions: 400° C./30 sec

GC-MS apparatus: 7890A(GC) 5975C(MS) manufactured by Agilent Technologies

Column: UA5HT-30M-0.1F manufactured by FRONTIER LAB

Conditions: Oven 40° C.->320° C. (20° C./min)

Column flow rate: 1 mL/min

Split ratio: 100:1

[Evaluation of Adhesion to Base Film]

The adhesion of the synthetic polymer film to the base film was evaluated as described in the following paragraph.

In an environment where the temperature was 23° C. and the humidity was 50%, 11 vertical incisions and 11 horizontal incisions were formed in a surface of a synthetic polymer film of each sample film (a surface opposite to the base) using a utility knife at intervals of 1 mm in the shape of a grid such that 100 squares (1 mm on each side) were formed. Then, a polyester adhesive tape “No. 31B” manufactured by NITTO DENKO CORPORATION was placed on and pressed against the square portions. Thereafter, the adhesive tape was peeled off in a direction of 900 with respect to the surface of the square portions at a velocity of 100 mm/s. Thereafter, the surface state of the synthetic polymer film on the base was visually observed, and the number of squares from which the polymer layer on the base was not removed, M, was counted. When the PC film was used as the base film (Examples 5 and 6), the evaluation was carried out at both transfer temperatures, 20° C. and 40° C., and the same results were obtained (the number of M was “100”).

[Evaluation of Film Surface Properties]

Degree of Spread of Water Over Synthetic Polymer Film

Deionized water was adjusted to pH=7.0±0.1 using 0.01 mol/L hydrochloric acid solution and 0.011 mol/L sodium hydroxide solution. That is, neutral water was prepared in this way.

On the surface of each sample film, a 0.2 cc (200 μL) drop of the above-described pH-adjusted water was placed using a micropipette. Thereafter, the maximum spread diameter (area equivalent circle diameter) up to 5 min was measured, and the average value for five measurements from each sample film was evaluated.

pH Measurement

The measurement of the pH was carried out as follows.

In the same way as that described above, on the surface of each sample film, a 0.2 cc (200 μL) drop of the above-described pH-adjusted water was placed using a micropipette. After the passage of 5 minutes, the aqueous solution (including water in which an extract from the synthetic polymer film was dissolved) on the surface of each sample film was measured using an electrode for flat samples which is described below, and the average value for five measurements from each sample film was evaluated (Method 1). Method 2 is different from Method 1 in that the above-described aqueous solution on the surface of each sample film was scooped up using a sampling sheet for measurement. Unless otherwise specified, Method 1 was used.

Electrode: pH electrode, product number: 0040-10D (semiconductor sensor) manufactured by HORIBA, Ltd.

Sampling sheet: sampling sheet B, product number: Y011A manufactured by HORIBA, Ltd.

Measurement of Static Contact Angle

The static contact angle of water and hexadecane with respect to the surface of the synthetic polymer film of each sample film was measured using a contact angle meter (PCA-1 manufactured by Kyowa Interface Science Co., Ltd). A drop of water or hexadecane (about 10 μL) was placed on the surface of the synthetic polymer film of each sample film. The static contact angle was measured at the lapse of 1 second, 10 seconds and 60 seconds since placing the water drop. The contact angle was measured at three locations by a θ/2 method (θ/2=arctan (h/r), θ: contact angle, r: radius of liquid drop, h: height of liquid drop), and the measurements at the three locations were averaged. Herein, the first measurement location was at a central portion of each sample film. The second and third measurement locations were away from the first measurement location by 20 mm or more and were in point symmetry with respect to the first measurement location. When the contact angle is not less than 1500, a liquid drop which was formed at the tip of a microsyringe and brought into contact with the surface sometimes failed to land on (move onto) the surface, i.e., remained at the tip of a microsyringe, so that the contact angle was unmeasurable. Such a case was indicated as “not landed”. That is, “not landed” means that the contact angle was not less than 1500°.

Evaluation of Anti-Smear Properties

Easiness in wiping away of grease (e.g., a fingerprint) adhered to the surface of the synthetic polymer film of each sample film was evaluated as described in the following paragraph. As described in the following paragraph, an artificially-contaminated solution was used in the experiment on the assumption that a fingerprint was adhered to the surface.

First, a black acrylic plate was adhered to a surface on the base film side of each sample film via an optical adhesive layer. Then, a “BEMCOT (registered trademark) S-2” wiper manufactured by Asahi Kasei Corporation was impregnated with a 0.1 mL artificially-contaminated solution manufactured by ISEKYU CO., LTD., and a finger wearing a rubber glove was brought into contact with the BEMCOT wiper such that the artificially-contaminated solution adhered to the rubber-gloved finger. Then, the artificially-contaminated solution adhered to the finger was transferred to the surface of each sample film (to the surface of the synthetic polymer film). After the passage of 10 minutes, the surface of each sample film (the surface of the synthetic polymer film) was rubbed with a “BEMCOT™ S-2” wiper manufactured by Asahi Kasei Corporation through ten reciprocations. Whether or not the artificially-contaminated solution was wiped away was visually checked in an environment at an illuminance of 100 lx (fluorescent lamp). The criteria for judgement were as follows:

∘: The artificially-contaminated solution was thoroughly wiped away. No remnant was found;

Δ: The artificially-contaminated solution was inconspicuous. However, when the fluorescent lamp was reflected in the surface, few remnants were found;

x: The artificially-contaminated solution was not wiped away at all.

Herein, when ∘ or Δ, the sample film was judged to be at a tolerable level (excellent in wiping away of fingerprint).

TABLE 4

| | | | | Film Surface Properties | | | | |
|---|---|---|---|---|---|---|---|---|
| | | | | | Water | | | |
| | Film Properties | | | | Diameter | Water Contact Angle (°) | | |
| | Acid Type | Color | Smell | pH | (mm) | 1 sec | 10 sec | 60 sec |
| Reference | TMBA | ∘ | Δ | 4.4 | 24.0 | 16.4 | 14.1 | 12.1 |
| Example 1 | | | | | | | | |
| Reference | TMBA/DPPA | ∘ | ∘ | 5.0 | 24.0 | 16.3 | 14.4 | 12.9 |
| Example 2 | | | | | | | | |
| Reference | BA | ∘ | x | 4.9 | 23.5 | 15.8 | 14.0 | 12.0 |
| Example 3 | | | | | | | | |
| Reference | — | ∘ | x | 6.9 | 25.5 | 11.8 | 10.9 | 9.4 |
| Example 4 | | | | | | | | |
| Reference | — | x | Δ | 7.0 | 24.0 | 15.1 | 12.9 | 11.6 |
| Example 5 | | | | | | | | |
| Reference | — | Δ | ∘ | 7.1 | 24.0 | 15.5 | 13.0 | 11.4 |
| Example 6 | | | | | | | | |
| Reference | — | ∘ | ∘ | 7.1 | 24.0 | 14.6 | 13.2 | 11.0 |
| Example 7 | | | | | | | | |
| Reference | — | ∘ | ∘ | 6.9 | 24.5 | 15.1 | 13.0 | 11.4 |
| Example 8 | | | | | | | | |

TABLE 5

| | | | | Film Surface Properties | | | | | | | | | |
|---|---|---|---|---|---|---|---|---|---|---|---|---|---|
| | | Film | | Water | | | Water Contact Angle | | | Hexadecane Contact | | | |
| | | Properties | | Diameter | pH | | (° C.) | | | Angle (°) | | | Anti- |
| | Adhesion | Color | Smell | (mm) | Method 1 | Method 2 | 1 sec | 10 sec | 60 sec | 1 sec | 10 sec | 60 sec | smear |
| Comparative | 100 | Δ | ∘ | 25.5 | 6.9 | 6.9 | 7.5 | 5.3 | 3.7 | 10.3 | 5.2 | 4.2 | x |
| Example 1 | | | | | | | | | | | | | |
| Comparative | 100 | Δ | ∘ | 9.0 | | | 120.0 | 117.1 | 111.1 | 8.9 | 6.8 | 6.0 | x |
| Example 2 | | | | | | | | | | | | | |
| Comparative | 100 | Δ | ∘ | 8.5 | | | 131.6 | 131.3 | 130.4 | 13.9 | 11.1 | 11.1 | x |
| Example 3 | | | | | | | | | | | | | |
| Example 1 | 100 | Δ | ∘ | 8.0 | 7.2 | 6.8 | not | | | 97.0 | 96.9 | 97.3 | ∘ |
| | | | | | | | landed | | | | | | |
| Example 2 | 100 | Δ | ∘ | 8.0 | 6.8 | 7.0 | not | | | 97.7 | 97.7 | 97.6 | ∘ |
| | | | | | | | landed | | | | | | |
| Example 3 | 100 | Δ | ∘ | 8.0 | 6.8 | 6.9 | not | | | 100.8 | 100.7 | 100.7 | ∘ |
| | | | | | | | landed | | | | | | |
| Example 4 | 100 | Δ | ∘ | 8.0 | 6.8 | 6.9 | not | | | 97.4 | 97.3 | 97.2 | ∘ |
| | | | | | | | landed | | | | | | |
| Comparative | 100 | Δ | ∘ | | | | | | | | | | x |
| Example 4 | | | | | | | | | | | | | |
| Comparative | 100 | Δ | ∘ | 9.0 | 4.6 | 5.7 | not | | | 101.5 | 101.4 | 101.2 | ∘ |
| Example 5 | | | | | | | landed | | | | | | |
| Example 5 | 100 | ∘ | ∘ | 8.0 | 6.9 | 6.9 | not | | | 99.0 | 98.7 | 99.0 | ∘ |
| | | | | | | | landed | | | | | | |
| Example 6 | 100 | ∘ | ∘ | 8.5 | 6.8 | 6.8 | not | | | 100.1 | 99.8 | 99.9 | ∘ |
| | | | | | | | landed | | | | | | |

Firstly, see the evaluation results of the sample films of Reference Examples 1 to 8 which are shown in TABLE 4.

The synthetic polymer films of Reference Examples 1 to 8 were produced using different types of photopolymerization initiators contained in the curable resin as shown in TABLE 2. The sample films of Reference Examples 1 to 8 each include a PET film as the base film and are different only in the type of the photopolymerization initiator contained in the curable resin for formation of the synthetic polymer film. The synthetic polymer films of Reference Examples 1 to 8 do not contain a polymerizable fluoric compound.

As shown in TABLE 4, the pH of the sample films of Reference Examples 1 to 3 was not more than 5. It can be seen that, in the synthetic polymer films of Reference Examples 1 to 3, the photopolymerization initiator generated an organic carboxylic acid through photodecomposition, and the organic carboxylic acid decreased the pH of water (aqueous solution) on the surface of the sample film. Polymerization initiator 819 used in Reference Example 1 generates 2,4,6-trimethylbenzoic acid (TMBA) through photodecomposition. Polymerization initiator TPO used in Reference Example 2 generates TMBA and diphenyl phosphoric acid (DPPA). Polymerization initiator OXEO1 used in Reference Example 3 generates benzoic acid (BA).

In contrast, the pH of the sample films of Reference Examples 4 to 8 was in the range of 6.9 to 7.1. It can be seen that the pH of water (aqueous solution) on the surface of the sample film scarcely changed. Polymerization initiators 907, 369, OXEO2, 127, and 2959 used in Reference Examples 4 to 8 did not generate an acid through photodecomposition. Therefore, when these photopolymerization initiators are used, a synthetic polymer film can be produced whose influence on the pH of water (aqueous solution) on the surface is small. Note that, however, as shown in TABLE 4, the sample film of Reference Example 4 emitted a smell, and the sample film of Reference Example 5 assumed a color. These sample films are sometimes not preferred in some uses. It is estimated that the smell and the color in the sample films which were detected in Reference Examples 4 and 5 were attributed to the polymerization initiators. As described in the following paragraphs, the sample films of Examples 1 to 6 of the present invention were produced using a polymerization initiator whose influence on the pH of water (aqueous solution) on the surface is small and which does not cause coloring or emission of a smell (i.e., polymerization initiators OXE02, 127, and 2959 used in Reference Examples 6 to 8).

Next, see the evaluation results of Examples 1 to 6 and Comparative Examples 1 to 5 which are shown in TABLE 5.

Each of the curable resins for production of the synthetic polymer films of Examples 1 to 6 includes a polyfunctional polymerizable fluoric compound. Each of Examples 1 to 6 has excellent water repellency (the static contact angle of water is not less than 150°), is excellent in anti-smear properties (easiness in wiping away of grease adhered to the surface), and exerts a small influence on the pH of water (aqueous solution) on the surface. In each of Examples 1 to 6, at the lapse of 5 minutes since placing a 200 μL drop of water on the surface of the synthetic polymer film, the pH of an aqueous solution is not less than 6.8 and not more than 7.2. Further, each of Examples 1 to 6 has excellent oil repellency (the static contact angle of hexadecane is not less than 900).

The synthetic polymer film of Example 1 is made of a curable resin which contains mold releasing agent MT70. Example 2 further contains mold releasing agent FAAC4 in addition to the composition of Example 1. Example 3 further contains mold releasing agent FAAC6 in addition to the composition of Example 1. Example 2 and Example 3 have greater static contact angles of hexadecane than Example 1. That is, Example 2 and Example 3 have better oil repellency than Example 1. Example 4 has the same composition as that of Example 3 except that mold releasing agent MT70 is replaced by mold releasing agent AD1700.

Comparative Examples 1 and 2 are made of respective curable resins which do not contain any polymerizable fluoric compound. Comparative Example 1 has the same composition as that of Example 1 except that mold releasing agent MT70 is replaced by mold releasing agent SAG003. Comparative Example 2 has the same composition as that of Example 1 except that mold releasing agent MT70 is replaced by mold releasing agent BYK3575. The sample films of Comparative Examples 1 and 2 do not have anti-smear properties or oil repellency.

Comparative Example 3 is made of a curable resin which contains a monofunctional polymerizable fluoric compound (FAAC4) but does not contain a polyfunctional polymerizable fluoric compound. The sample film of Comparative Example 3 does not have anti-smear properties or oil repellency. It can be seen that containing solely a monofunctional polymerizable fluoric compound does not contribute to achievement of sufficient anti-smear properties and sufficient oil repellency in some cases.

Comparative Example 4 was formed using a curable resin which had the same composition as that of Example 3 but using a glass plate as the mold sample. That is, the synthetic polymer film of Comparative Example 4 does not have a plurality of raised portions (moth-eye structure) at the surface. The sample film of Comparative Example 4 does not have anti-smear properties.

Comparative Example 5 has the same composition as that of Example 3 except that polymerization initiator OXE02 is replaced by polymerization initiator 819. Polymerization initiator 819 generates an organic carboxylic acid through photodecomposition and therefore decreases the pH of water (aqueous solution) on the surface of the sample film. The sample film of Comparative Example 5 is excellent in anti-smear properties, water repellency and oil repellency but decreases the pH of water (aqueous solution) on the surface.

The sample films of Examples 1 to 4 include a TAC film as the base film. In contrast, the sample films of Examples 5 and 6 include a PET film as the base film.

As disclosed in Japanese Patent Application No. 2017-176590 of the present applicant, the present applicant found that a 2-(2-vinyloxy ethoxy)ethyl (meth)acrylate monomer was a promising candidate for the acrylic monomer which can improve adhesion with a PC film. The entire disclosures of Japanese Patent Application No. 2017-176590 are incorporated by reference in this specification. If the proportion of a 2-(2-vinyloxy ethoxy)ethyl (meth)acrylate monomer unit contained in the cross-linked structure of a synthetic polymer film to the entirety of the synthetic polymer film is, for example, not less than 15 mass % and less than 45 mass %, the synthetic polymer film can have excellent PC adhesion. PC is a resin which generally exhibits high physical properties among engineering plastics and has been widely used particularly because of its excellent shock resistance and heat resistance.

In Examples 5 and 6, VEEA manufactured by NIPPON SHOKUBAI CO., LTD. was used as the 2-(2-vinyloxy ethoxy)ethyl acrylate. In Example 5, polymerization initiator 127 was used. Example 6 has the same composition as that of Example 5 except that polymerization initiator 127 is replaced by polymerization initiator 2959. Both Examples 5 and 6 have excellent adhesion with a PC film. Note that each of Examples 1 to 4 in which a TAC film was used as the base film has acceptable adhesion with a TAC film.

The other examples of the PC film than those used in the above-described examples include “CARBOGLASS (registered trademark)” manufactured by AGC Inc., “PUREACE (registered trademark)” manufactured by TEIJIN LIMITED, and “Makrofol (registered trademark)” manufactured by Covestro.

In the foregoing, an example of a multilayer film including a polycarbonate film and a synthetic polymer film wherein the polycarbonate film was used as the base film has been described, although the present invention is not limited to this example. For example, a plastic molded product of polycarbonate can be used as the plastic base. In this case, a moth-eye mold may be used which is manufactured using an aluminum film deposited on a glass base of a desired shape.

By laminating a molded product of various shapes with a multilayer film which includes a polycarbonate film and a synthetic polymer film, excellent anti-smear properties and excellent water repellency can be given to the surface of the molded product of various shapes, and a surface can be realized which exerts a small influence on the pH of water (aqueous solution) on the surface.

As illustrated with the experimental examples, when a synthetic polymer film is made of a curable resin which contains a polymerizable fluoric compound which has a plurality of polymerizable functional groups, the synthetic polymer film can have excellent water repellency and excellent anti-smear properties. Such a synthetic polymer film is also excellent in durability of the water repellency and anti-smear properties at the surface. For example, a synthetic polymer film can be realized on which the static contact angle of water with respect to the surface of the synthetic polymer film is not less than 1000, and the static contact angle of hexadecane with respect to the surface of the synthetic polymer film is not less than 500. The static contact angle of water with respect to the surface of the synthetic polymer film is, more preferably, not less than 1500. The static contact angle of hexadecane with respect to the surface of the synthetic polymer film is, more preferably, not less than 900

The polymerizable fluoric compound which has polymerizable functional groups includes, for example, a fluorine-containing hydrocarbon chain and a (meth)acrylate group at the terminal. The fluorine-containing hydrocarbon chain is likely to reside near the surface of curable resin. A synthetic polymer film which is realized by curing such a curable resin has excellent water repellency and excellent anti-smear properties. When the surface of the moth-eye mold is treated with a fluoric mold releasing agent, the proportion of the fluorine element contained near the surface of the synthetic polymer film can further increase. Thus, such a treatment is more preferred from the viewpoint of excellent water repellency and excellent anti-smear properties. The proportion of the polyfunctional polymerizable fluoric compound to the curable resin is preferably not less than 1 mass % and not more than 5 mass %.

In order that the polyfunctional polymerizable fluoric compound exhibits excellent water repellency and excellent anti-smear properties, it is preferred that the length (volume) of the fluorine-containing hydrocarbon chain has an appropriate size. If the length (volume) of the fluorine-containing hydrocarbon chain is excessively large, it is sometimes difficult for the fluorine-containing hydrocarbon chain to move to the vicinity of the surface of the synthetic polymer film. As illustrated with the experimental examples, this problem can be solved by using together a monofunctional polymerizable fluoric compound which has a relatively lower molecular weight. If the length (volume) of the fluorine-containing hydrocarbon chain is excessively large, the solubility of the polymerizable fluoric compound to the other monomers of the curable resin decreases, and curing the curable resin sometimes results in a whitened synthetic polymer film.

For example, the polyfunctional polymerizable fluoric compound preferably has a molecular weight of not less than 1000 and not more than 5000. The molecular weight of the polyfunctional polymerizable fluoric compound is, more preferably, not less than 2000 and not more than 4000. A polyfunctional polymerizable fluoric compound which has a relatively large molecular weight such as described above preferably has two, three or four polymerizable functional groups, for example. The proportion of the fluorine element contained in the polyfunctional polymerizable fluoric compound is, for example, preferably not less than 20 mass % and not more than 60 mass %, more preferably not less than 30 mass % and not more than 50 mass %.

Examples of the polyfunctional polymerizable fluoric compound, other than those used in the above-described examples, include “Y-1200” and “X-71-1203M” manufactured by Shin-Etsu Chemical Co., Ltd., “DAC-HP” manufactured by DAIKIN INDUSTRIES, LTD., “MEGAFACE RS-72-K”, “MEGAFACE RS-75”, “MEGAFACE RS-76-E”, “MEGAFACE RS-76-NS” and “MEGAFACE RS-77” manufactured by DIC Corporation, and “EBECRYL8110” manufactured by DAICEL-ALLNEX LTD.

For example, DAC-HP manufactured by DAIKIN INDUSTRIES, LTD. has two polymerizable functional groups. The molecular weight is 1169 to 1999, and the proportion of the contained fluorine element is 24.4 mass % to 42.8 mass % (all these numbers are estimates).

As illustrated with the experimental examples, when the curable resin used for formation of the synthetic polymer film further contains a monofunctional polymerizable fluoric compound, the synthetic polymer film can have more excellent water repellency and more excellent anti-smear properties. The molecular weight of the monofunctional polymerizable fluoric compound is preferably not less than 100 and not more than 1000, more preferably not less than 300 and not more than 500. The proportion of fluorine element contained in the monofunctional polymerizable fluoric compound is, for example, preferably not less than 40 mass % and not more than 70 mass %, more preferably not less than 50 mass % and not more than 60 mass %.

Examples of the monofunctional polymerizable fluoric compound, other than those used in the above-described examples, include “CHEMINOX FAMAC-4” and “CHEMINOX FAMAC-6” manufactured by UNIMATEC Co., Ltd. and Product ID “C8ACRY”, “C8MTCRY”, “C10ACRY” and “C10MTCRY” manufactured by Exfluor Research Corporation.

In the experimental examples, the polymerizable fluoric compound is referred to as “mold releasing agent”, although the present invention is not limited to this example. A fluoric compound which meets the above-described conditions may be used.

A synthetic polymer film of an embodiment of the present invention has a surface which is excellent in water repellency and anti-smear properties and exerts a small influence on the pH of water (aqueous solution) on the surface. A synthetic polymer film of an embodiment of the present invention is suitably used in, for example, a film for food or a plastic product for food.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Application No. 2018-041073 filed on Mar. 7, 2018, the entire contents of which are hereby incorporated by reference.

What is claimed is:

1. A synthetic polymer film whose surface has a plurality of raised portions, wherein
when viewed in a normal direction of the synthetic polymer film, a two-dimensional size of the plurality of raised portions is in the range of more than 20 nm and less than 500 nm,
the synthetic polymer film is made of a curable resin which contains a first polymerizable fluoric compound, the first polymerizable fluoric compound containing a fluorine element,
the first polymerizable fluoric compound has a plurality of polymerizable functional groups and has a molecular weight of not less than 1000 and not more than 5000, and
at the lapse of 5 minutes since placing a 200 μL drop of water on the surface of the synthetic polymer film, a pH of an aqueous solution is not less than 6.5 and not more than 7.5.

2. The synthetic polymer film of claim 1, wherein at the lapse of 5 minutes since placing a 200 μL drop of water on the surface of the synthetic polymer film, a pH of an aqueous solution is not less than 6.8 and not more than 7.2.

3. The synthetic polymer film of claim 1, wherein
the curable resin is a photocurable resin which contains a photopolymerization initiator, and
the photopolymerization initiator contains at least one of the group consisting of ethanone,1-[9-ethyl-6-(2-methylbenzoyl)-9H-carbazole-3-yl]-,1-(O-acetyloxime), 2-hydroxy-1-{4-[4-(2-hydroxy-2-methyl-propionyl)-benzyl]-phenyl}-2-methyl-propan-1-one, and 1-[4-(2-hydroxyethoxy)-phenyl]-2-hydroxy-2-methyl-1-propane-1-one.

4. The synthetic polymer film of claim 1, wherein
the curable resin further contains a second polymerizable fluoric compound which contains a fluorine element, and
the second polymerizable fluoric compound is a monofunctional polymerizable compound and has a molecular weight of not less than 100 and not more than 1000.

5. The synthetic polymer film of claim 1, wherein a proportion of the first polymerizable fluoric compound to the curable resin is not less than 1 mass % and not more than 5 mass %.

6. The synthetic polymer film of claim 1, wherein a static contact angle of water with respect to the surface is not less than 1000°.

7. The synthetic polymer film of claim 1, wherein a static contact angle of hexadecane with respect to the surface is not less than 500.

8. The synthetic polymer film of claim 1, wherein
the synthetic polymer film includes a cross-linked structure, and
the cross-linked structure includes a 2-(2-vinyloxy ethoxy)ethyl (meth)acrylate monomer unit.

9. A plastic product, comprising:
a plastic base which has a surface, and
the synthetic polymer film as set forth in claim 1, the synthetic polymer film being provided on the surface of the plastic base.

10. The plastic product of claim 9, wherein the surface of the plastic base is made of polycarbonate.
